(19) United States
(12) Patent Application Publication
(10) Pub. No.: US 2002/0056407 A1
(43) Pub. Date: May 16, 2002

(54) Disc opener

(76) Inventor: Ross Vincent Milne, Dalby (AU)

Correspondence Address: RENNER, OTTO, BOISSELLE & SKLAR, LLP, Nineteenth Floor, 1621 Euclid Avenue, Cleveland, OH, 44115-2191, US

(21) Appl. No.: 09/945,883

(22) Filed: Sep. 4, 2001

(30) Foreign Application Priority Data
Nov. 10, 2000 (AU) PR1402
Aug. 6, 2001 (AU) 57824/01

(51) Int. Cl. A01C 5/00

(52) U.S. Cl. 111/192; 111/194; 111/163; 111/924; 111/81; 172/701; 172/538

(57) ABSTRACT

A disc opener for no till or minimum till seeding and/or fertilizing operations, the opener having a frame adapted to move in a forward direction of travel, an opening disc for forming a furrow in soil when moved in the forward direction, the disc being rotatably mounted to the frame and inclined in the direction of travel to provide a leading and a trailing surface, means for dispensing seed and/or fertilizer into the furrow, a soil retaining wheel mounted to the frame and set to run along an undisturbed soil surface behind the trailing edge of the leading surface of the opening disc in substantially the same direction as the direction of travel, such that in use the soil retaining wheel replaces soil from the furrow formed by the opening disc and also controls the depth of the furrow.

### FIELD OF THE INVENTION

The present invention relates to an agricultural implement and in particular a disc opener and seeder for use in zero or minimal till seeding and fertilizing operations.

### BACKGROUND ART

Traditionally, after a crop has been harvested, a field is tilled so as to bury the harvest residue into the soil such that the soil is ready for planting. However, there are a number of economic and environmental disadvantages with such methods. First, tilling the soil with implements such as ploughs, is energy intensive and time consuming. Ploughing operations require large horsepower tractors and thus fuel costs are significant together, with investing a considerable investment of a farmers time. Still further, tilling incorporates weed seeds into the soil which encourages weed growth.

The crop residue and trash which remains on the soil surface after harvest can protect the soil surface from water run off and erosion and loss of moisture from the soil by evaporation. It may also inhibit weed growth. Removal of the surface layer by tilling the soil can therefore result in soil erosion, moisture loss and encourage weed growth, which can translate to an increase in herbicide use.

In order to overcome these difficulties, operations referred to as zero or minimal tilling have been practiced. Zero tillage refers to the practice of directly planting seed into a field without pre seeding tilling. Zero or minimum tillage practices employ implements known as soil openers. One type of opener is referred to as a disc opener. These openers have a vertical disc inclined to the direction of travel cuts a narrow furrow in the soil. After placement of the seed in the furrow, by a seed tube or the like, the furrow is closed and the soil compacted by a packing wheel.

In practice, there are a number of difficulties with conventional zero tillage implements. A major problem is known as “hairpinning” which occurs when straw, trash and/or crop residue becomes embedded in the furrow when the disc of the disc opener does not completely cut through the trash and forces the debris into the furrow. Seed is dispensed into the furrow and onto the trash. As the trailing half of the disc retracts from the furrow, the disc can drag some of the trash from the furrow, taking seed with it. Seed which remains in the furrow will not germinate in an optimum manner if it is in contact with trash rather than soil. Further, erratic seed placement caused by hairpinning will result in poor and non uniform germination. This can significantly affect the final crop. Hairpinning can also cause moisture loss due to the wicking action of exposed portions of straw, trash and/or crop residue.

Various methods have been developed in an attempt to address the hairpinning problems. One commercially available zero till implement incorporates a disc opener known as the Barton opener. The Barton opener has an upright rotating disc which is inclined in both the vertical and horizontal directions. The disc has a diameter of 18 inches (45 cm). A disc inclined in both the vertical and horizontal directions is claimed to slice through the soil at an angle rather than compressing the soil as with conventional vertical discs. It is believed that the slicing action is also more efficient in cutting through the trash which reduces hairpinning.

The Barton opener also has a 4.5 inch (11.4 cm) diameter cleaning wheel mounted parallel to the opening disc, The cleaning wheel controls soil thrown during furrow formation and cleans the opening disc. The axle of the cleaning wheel is connected to a crank assembly The cleaning wheel is set to run above ground level. This is important to the operation of the Barton opener. If the cleaning wheel ran along the ground it would compact the soil making furrow closure more difficult. The Barton opener also has a rear packing wheel set at the opposite inclination to the opening disc. The packing wheel closes and compacts the soil and also controls furrow depth.

In practice it has been observed that there are a number of difficulties associated with use of the Barton opener. First, when used in heavy or wet soils, the opening disc picks up soil and can become blocked. This results in stalling of the opening disc which then drags along the ground. As mentioned above, furrow depth is controlled by the rear packing wheel. The packing wheel is spaced from the seed delivery tube which is located in the region of the opening disc. This is acceptable if the ground is even. In practice this is rarely the case. On uneven the ground, the packing wheel can be lifted by a bump which then lifts the opening disc which results in uneven furrow depth.

A further disadvantage with such an arrangement is that the pressure of the packing wheel cannot be varied independently of the furrow depth. Independent adjustment may be desirable to optimize soil compaction, particularly in the case of soft friable soils which is the result of successful zero till farming Providing a gauge wheel located adjacent the opening disc may at least partially address the problems associated with the packing wheel controlling the depth. However, as stated above, such an arrangement is unacceptable with the Barton opener.

Another approach to addressing the hairpinning problem which has been proposed is to provide a disc opener having press wheels on either side of a conventional 18 inch (45 cm) vertical opening disc. The press wheels hold the trash on either side of the opening disc such that the disc can more easily slice through the trash. The press wheels contribute to the complexity and cost of this type of opener. Further, the press wheels may cause undesirable compaction of the soil. Still further, the presence of the press wheels increases the width of the opener and in a corresponding increase in the width between plant rows. This results in fewer plant rows and reduced crop production.

This type of opener has a soil retaining wheel mounted parallel to the opening disc and adjacent the trailing edge. The soil retaining wheel cleans the opening disc of soil, but more importantly reduces soil disturbance and replaces soil into the furrow after seed placement. The soil retaining wheel is set to run above the ground and in use contacts the raised soil disturbed by furrow formation and pushes the soil back into the furrow. A rear packing wheel mounted at an angle opposite to that of the opening disc compacts the soil.

In this device, seeding depth is controlled by the front press wheels. Because these wheels are spaced from the seed tubes the same types of difficulties in relation to nonuniform furrow depth as discussed above with respect to the Barton opener can be experienced. As with the Barton opener, setting the soil retaining wheel to run on the ground is unacceptable as this adversely affects the ability of the wheel to control soil disturbance.

It is therefore an object of the present invention to provide a disc opener for zero or minimal tillage operations which may at least partially overcome the above disadvantages or provide the public with a useful choice.

### OBJECT OF THE INVENTION

According to a first broad form of the invention, there is provided a disc opener for no till or minimum till seeding and/or fertilizing operations, the opener having a frame adapted to move in a forward direction of travel, an opening disc for forming a furrow in soil when moved in the forward direction, the disc being rotatably mounted to the frame and inclined in the direction of travel to provide a leading and a trailing surface, means for dispensing seed and/or fertilizer into the furrow, a soil retaining wheel mounted to the frame and set to run along an undisturbed soil surface behind the trailing edge of the leading surface of the opening disc in substantially the same direction as the direction of travel, such that in use the soil retaining wheel replaces soil from the furrow formed by the opening disc and also controls the depth of the furrow.

The disc opener of the present invention has an opening disc inclined to the direction of travel or in other words is set at an angle to the horizontal. The angle of inclination may be varied to suit different situations such as varying soil type and hardness, moisture content or amount of organic material on the soil surface. Typically the angle of inclination to the horizontal is between about 4 to about 7°.

The opening disc may be aligned vertically or may be set at an angle to the vertical. Again the vertical angle of inclination may be varied to suit the conditions. Typically the vertical angle varies between 0 and about 10°. When set at 0° a vertical furrow is formed. When set at an angle, and furrow inclined to the vertical is formed.

The opening disc typically has a diameter of between 20 to about 24 inches (about 50 to about 60 cm). This diameter is larger than the diameter of conventional opening discs which have a maximum diameter of about 18 inches (45 cm). The present inventor has surprisingly and unexpectedly discovered that by providing an opening disc having a larger diameter than conventional opening discs, that this can facilitate cutting through the trash, even when the disc is at an angle of 0° to the vertical. This reduces hairpinning.

Typically, the disc opener includes a rotary scraper blade running on the upper side of the disc. This blade assists in removing any soil adhering to the disc.

The disc opener includes means for dispensing seed and/or fertilizer into the furrow. Devices for dispensing seed and/or fertilizer are well known the art and need not be further described. However, a seed delivery system of the air seeder type is particularly preferred. Typically, a seed delivery tube is fitted to the underside of the opening disc.

The disc opener includes a soil retaining wheel mounted substantially parallel to the direction of travel. The wheel is mounted such that it runs along the ground on the same side of the device as of the leading surface of the opening disc and behind the trailing edge of the opening disc. It will be appreciated that there may be minor variations to the orientation of the wheel, such as the angle, and these may be tolerated, provided the wheel travels on the undisturbed ground and continues to replace displaced soil into the furrow behind the opening disc.

When a furrow is formed by the opening disc, soil is displaced and a raised area of soil is formed along the side of furrow which is adjacent to the leading surface of the opening disc. The soil retaining wheel, following behind the trailing edge of the opening disc, throws the displaced soil back into the furrow. The present inventor has surprisingly and unexpectedly observed that by setting the wheel to run in substantially the same direction as the direction of travel that the action of the wheel in returning soil to the furrow is more efficient than the prior art inclined soil retaining wheels.

The soil retaining wheel is set to run along the undisturbed soil and controls the depth at which the opening disc travels through the soil and consequently the furrow depth. The wheel is typically set to run along the ground adjacent or near where the seed and/or fertilizer is dispensed into the furrow. In this way, the depth is controlled at where the seed is dispensed as opposed to the depth being regulated by a rear packing wheel spaced from the site of seed delivery as in prior art devices. It has been found that by having the depth control means located to the side of the opening disc, more accurate seed depth can be obtained. Accurate seed depth is important for optimizing germination.

The soil retaining wheel typically has a diameter of the same or similar order of magnitude to the opening disc. The present inventor has surprisingly observed that a larger diameter of the opening disc and/or soil retaining wheel can reduce soil build up. This may be especially important in wet and/or heavy soils.

Typically, a shield is provided within the shadow created by the forward movement of the disc opener which can reduce the entry of dry soil into the narrow furrow before the furrow is closed.

Typically, the disc opener of the present invention further includes a rear packing wheel for compacting the furrow after it has been filled in by the action of the soil retaining wheel. The packing wheel may be oriented at any angle. Preferably, the packing wheel is set at the same angle to the direction of travel as the opening disc. Where the opening disc is also inclined at an angle to the horizontal, it is preferred that the packing wheel is inclined at substantially the same angle to the vertical. In this way, the packing wheel compacts the soil in the furrow from the same angle as that which the furrow was made.

The present inventor has surprisingly and unexpectedly discovered that by orientating the packing wheel in this manner, a more positive seed to soil contact may be obtained than when the packing wheel is oriented in the opposite direction to the opening disc as taught by the prior art. The more positive seed to soil contact facilitates germination and improves plant vigor.

### BRIEF DESCRIPTION OF THE DRAWINGS

By way of example only, the present invention will now be described with reference to the accompanying figures in which;

FIG. 1 is a plan view of a preferred disc opener of the present invention;

FIG. 2 is a front side view of the disc opener of FIG. 1 and

FIG. 3 is a rear side view of the disc opener of FIG. 1.

FIG. 4 is a plan view of the disc opener in greater detail and having the soil retaining wheel rotating about an axle which is substantially parallel to the ground surface.

FIG. 5 is a plan view of the disc opener of FIG. 4 but where the soil retaining wheel rotates about an axle which is slightly inclined relative to the ground surface.

### BEST MODE

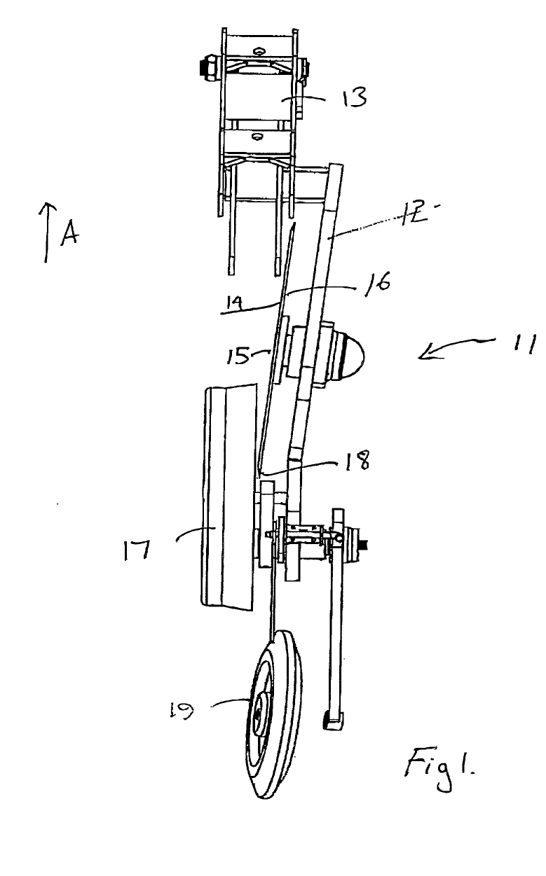

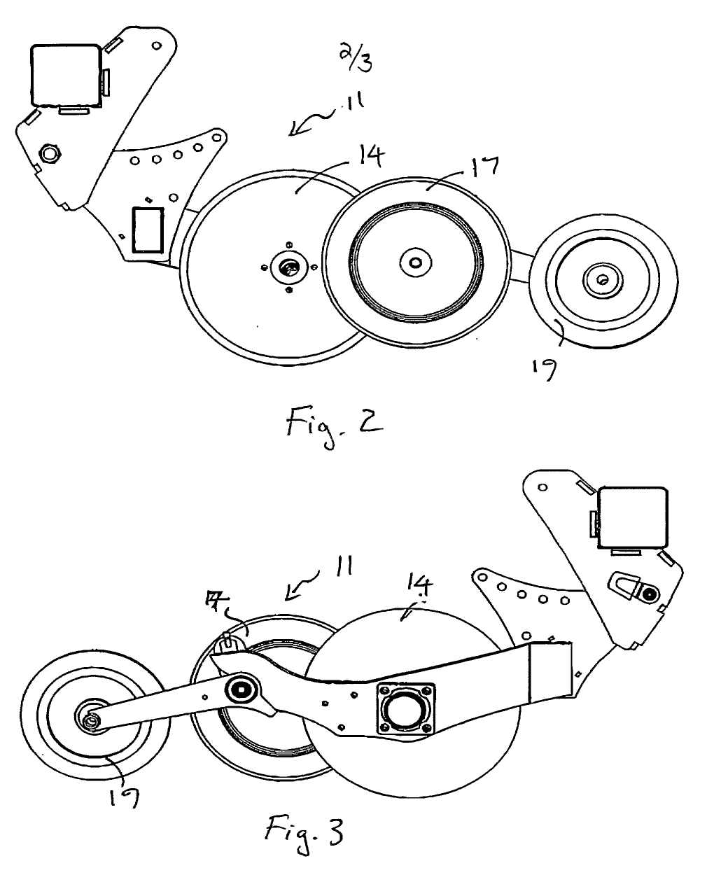

FIG. 1 illustrates a preferred disc opener 11 of the present invention. The disc opener 11 has a frame 12 with a connecting arm 13 for connecting the disc opener 11 to a tool bar (not illustrated) which in turn is hitched to a tractor. A plurality of disc openers 11, may be mounted to a tool bar.

The disc opener 11 has an opening disc 14 rotatably mounted to frame 12. The opening disc 14 is set at an angle of between about 4 to about 10° to the direction of travel A so as to define leading 15 and a trailing surface 16. The opening disc has a diameter of about 22 inches (55 cm).

The disc opener 11 includes a soil retaining wheel 17 which is set to run in the direction of travel and behind the trailing edge 18 of the opening disc 14. The soil retaining wheel 17 is mounted to the same side of the disc opener 11 as the leading surface 15 of the disc opener 14, The soil retaining wheel 17 has the same diameter as the opening disc 14 and a width of about 100 mm. A seed delivery tube (not illustrated) is fitted to the underside of the opening disc 14 and feeds seed and/or fertilizer into a furrow formed by the forward movement of opening disc 14.

In use, the soil retaining wheel 17 is in constant contact with the undisturbed soil to the side of the furrow and therefore acts to control the depth at which the opening disc operates. It can be seen that the depth is controlled at the same location as where the seed is dispensed. This can provide for an improved accuracy of planting when compared to prior art devices which rely on forward or rear wheels for gauging depth.

The soil retaining wheel 17 also functions to prevent soil being thrown away from the furrow and to replace displaced soil into the furrow. When a furrow is formed, a raised portion of displaced soil is formed along the edge of the furrow on the same side of the furrow as the leading surface 15 of the opening disc 14.

The present inventor has surprisingly and unexpectedly observed that the arrangement of the soil retaining wheel and disc opener of the present invention is unlikely to clog and stall during to a build up of soil as opposed to the prior art Barton disc opener.

The disc opener 11 further includes a rear packing wheel 19 mounted on arm 20. Arm 20 is operatively associated with a loaded spring arrangement so as to allow the compacting pressure of the packing wheel to be varied. Packing wheel 19 is inclined to the vertical and horizontal at the same angles as the opening disc 14. By compacting the soil from the same angle by which the furrow was formed a more positive compaction and improved seed to soil and seed to moisture contact.

In use, the disc opener travels in a forward direction and opening disc 11 forms a vertical in the ground and a raised area of displaced soil is formed along the side of the furrow adjacent the leading surface 15 of the opening disc 14. Seed and/or fertilizer is deposited into the furrow. The depth at which the seed is deposited is accurately controlled as wheel 17 is in constant contact with the undisturbed soil to the side of the disturbed, raised section of soil. Wheel 17 returns the displaced soil into the furrow. The returned soil is then compacted by packing wheel 19. The packing wheel runs at the same angle as the opening disc, so that the compacting force is exerted in line with the angle of formation of the furrow.

It can be seen that the disc opener of the present advantages enables seeding and fertilizing operations to be conducted with accurate seed depth, minimal soil disturbance and optimized soil compaction. Further, the opening disc is less likely to clog and stall as per prior art devices. Still further, hairpinning can be reduced.

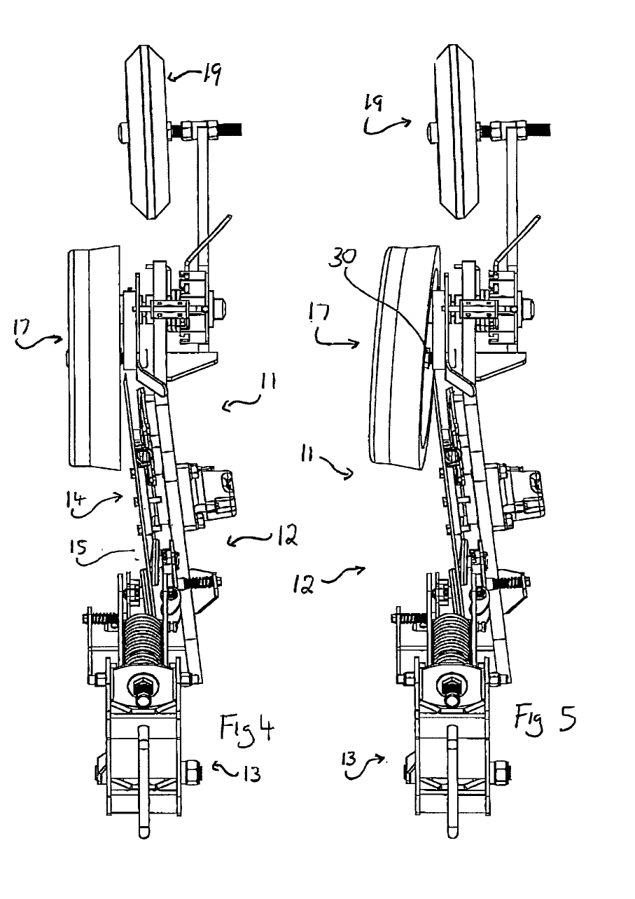

FIG. 4 is a plan view of the opener in greater detail and like reference numerals have been used to designate like parts.

FIG. 5 is a plan view of a slightly modified opener in which the soil retaining wheel 17 rotates about an axle 30 which is inclined by 1.5° to cause the soil retaining wheel 17 to be angled towards the furrow to allow a more aggressive replacement of soil into the furrow in certain soil conditions. It is envisaged that the angle may be varied either by removing the axle and replacing the axle with axles having different angles, or by having the axle mounted to the remainder of the frame in such a manner that it can be angled to cause the soil retaining wheel 17 to be angled towards the furrow.

I claim:

1. A disc opener for no till or minimum till seeding and/or fertilizing operations, the opener having a frame adapted to move in a forward direction of travel, an opening disc for forming a furrow in soil when moved in the forward direction, the disc being rotatably mounted to the frame and inclined in the direction of travel to provide a leading and a trailing surface, means for dispensing seed and/or fertilizer into the furrow, a soil retaining wheel mounted to the frame and set to run along an undisturbed soil surface behind the trailing edge of the leading surface of the opening disc in substantially the same direction as the direction of travel, such that in use the soil retaining wheel replaces soil from the furrow formed by the opening disc and also controls the depth of the furrow.

2. The disc opener of claim 1, wherein the opening disc has a diameter of between about 50 to about 60 cm.

3. The disc opener of claim 1, wherein the disc opener has an opening disc inclined to the direction of travel of between about 4 to about 7°.

4. The disc opener of claim 3, wherein the opening disc is aligned vertically of between 0 and about 10°.

5. The disc opener of claim 4, wherein the disc opener includes a rotary scraper blade running on the upper side of the disc.

6. The disc opener of claim 5, wherein the disc opener includes means for dispensing seed and/or fertilizer into the furrow.

7. The disc opener as claimed in claim 6, wherein the means for dispensing seed and/or fertiliser is an air seeder.

8. The disc opener of claim 1, wherein the soil retaining wheel is mounted such that it runs along the ground on the same side of the device as of the leading surface of the opening disc and behind the trailing edge of the opening disc.

9. The disc opener of claim 8, wherein the soil retaining wheel has a diameter of between 50-60 cm.

10. The disc opener of claim 8, wherein a shield is provided within the shadow created by the forward movement of the disc opener to reduce the entry of dry soil into the narrow furrow before the furrow is closed.

11. The disc opener of claim 10, including a rear packing wheel for compacting the furrow after it has been filled in by the action of the soil retaining wheel.

12. The disc opener as claimed in claim 11 wherein the packing wheel is set at the same angle to the direction of travel as the opening disc.

13. The disc opener of claim 1, wherein the soil retaining wheel rotates about an axle which is substantially parallel to the ground surface.

14. The disc opener as claimed in any one of claim 1, wherein the soil retaining wheel rotates about axle which is inclined relative to the ground surface.

15. The disc opener of claim 14, wherein the axle is inclined by between 1-3° to incline the soil retaining wheel towards the furrow.

16. The opener of claim 15, wherein the axle is inclined by 1.5°.
